(19) United States
(12) Patent Application Publication
(10) Pub. No.: US 2025/0004817 A1
(43) Pub. Date: Jan. 2, 2025

(54) MANAGING DEPLOYMENT OF CUSTOM RESOURCES IN A CONTAINER ORCHESTRATION SYSTEM

(71) Applicant: VMWARE, INC., Palo Alto, CA (US)

(72) Inventors: PALLA GOLLA DWARAKESH, Bangalore (IN); Anand PRITAM, Bangalore (IN); Venu Gopala Rao KOTHA, Bangalore (IN); MIthlesh KUMAR, Bangalore (IN)

(21) Appl. No.: 18/376,856

(22) Filed: Oct. 5, 2023

(30) Foreign Application Priority Data
Jun. 30, 2023 (IN) 202341043971

(51) Int. Cl. G06F 9/455

(52) U.S. Cl. CPC G06F 9/45558; G06F 2009/4557; G06F 2009/45595

(57) ABSTRACT

An example method of managing a custom resource in a container orchestration (CO) system includes: receiving, from a manager at a management cluster of the CO system, an intent identifier, the management cluster including a controller configured to manage the custom resource, the management cluster storing the intent identifier in a database; receiving, from the manager at the management cluster, a request that updates state of the custom resource; determining, at the management cluster, a match between an intent identifier in the request and the intent identifier stored in the database; and executing, by the controller of the management cluster, a management process for the custom resource in the CO system in response to the match and the request.

### RELATED APPLICATIONS

Benefit is claimed under 35 U.S.C. 119(a)-(d) to Foreign application No. 202341043971 filed in India entitled “MANAGING DEPLOYMENT OF CUSTOM RESOURCES IN A CONTAINER ORCHESTRATION SYSTEM”, on Jun. 30, 2023, by VMware, Inc., which is herein incorporated in its entirety by reference for all purposes.

### BACKGROUND

Applications today are deployed onto a combination of virtual machines (VMs), containers, application services, and more. For deploying such applications, a container orchestrator (CO) known as Kubernetes® has gained in popularity among application developers. Kubernetes provides a platform for automating deployment, scaling, and operations of application containers across clusters of hosts. It offers flexibility in application development and offers several useful tools for scaling.

In a Kubernetes system, containers are grouped into logical unit called “pod” that execute on nodes in a cluster. Containers in the same pod share the same resources and network and maintain a degree of isolation from containers in other pods. The pods are distributed across nodes of the cluster. In a typical deployment, a node includes an operating system (OS), such as Linux®, and a container engine executing on top of the OS that supports the containers of the pod. A node can be a physical server or a VM.

In a radio access network (RAN) deployment, such as a 5G RAN deployment, cell site network functions can be realized as Kubernetes pods. Each cell site can be deployed with one or more servers. Containerized network functions (CNFs) execute in the servers of the cell sites. Kubernetes clusters and CNFs can be deployed to cell sites using custom resources (CRs). A CR is a mechanism for extending the Kubernetes application programming interface (API) by defining a new resource type. CRs allow an operator to define custom resources that can be managed the same way as built-in resources, such as deployments, pods, services, and the like. A managed Kubernetes environment, such as a RAN deployment, can include a controller and several worker nodes. The controller provides a unified interface that can be used to deploy CRs on the worker nodes.

Deploying a custom resource in a CO system can be a long-running process. However, a user is allowed to modify or delete a custom resource at any point and the CO system accepts and works toward achieving the new CR's state. This can result in conflicts if the user creates a CR, deployment of the CR initiates a long running process, and the user modifies the CR before the long running process has completed. In such case, the CO system would initiate a second long running process in response to the modification of the CO, which can conflict with the first long running process that has yet to be completed. This can leave the CO system in an inconsistent state.

### SUMMARY

In an embodiment, a method of managing a custom resource in a container orchestration (CO) system is described. The method includes receiving, from a manager at a management cluster of the CO system, an intent identifier. The management cluster includes a controller configured to manage the custom resource. The management cluster stores the intent identifier in a database. The method includes receiving, from the manager at the management cluster, a request that updates state of the custom resource. The method includes determining, at the management cluster, a match between an intent identifier in the request and the intent identifier stored in the database. The method includes executing, by the controller of the management cluster, a management process for the custom resource in the CO system in response to the match and the request.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtualized computing system in which embodiments described herein may be implemented.

FIG. 2 is a block diagram depicting a server of a site according to embodiments.

FIG. 3 is a block diagram depicting a CO system according to embodiments.

FIG. 4 is a block diagram depicting data flow in the CO system according to embodiments.

FIG. 5 is a flow diagram depicting a method of handling CR requests in a CO system according to embodiments.

FIG. 6 is a flow diagram depicting a method of executing management processes in response to CR requests in a CO system according to embodiments.

FIG. 7 is a flow diagram depicting a method of executing management processes in response to CR requests in a CO system according to embodiments.

### DETAILED DESCRIPTION

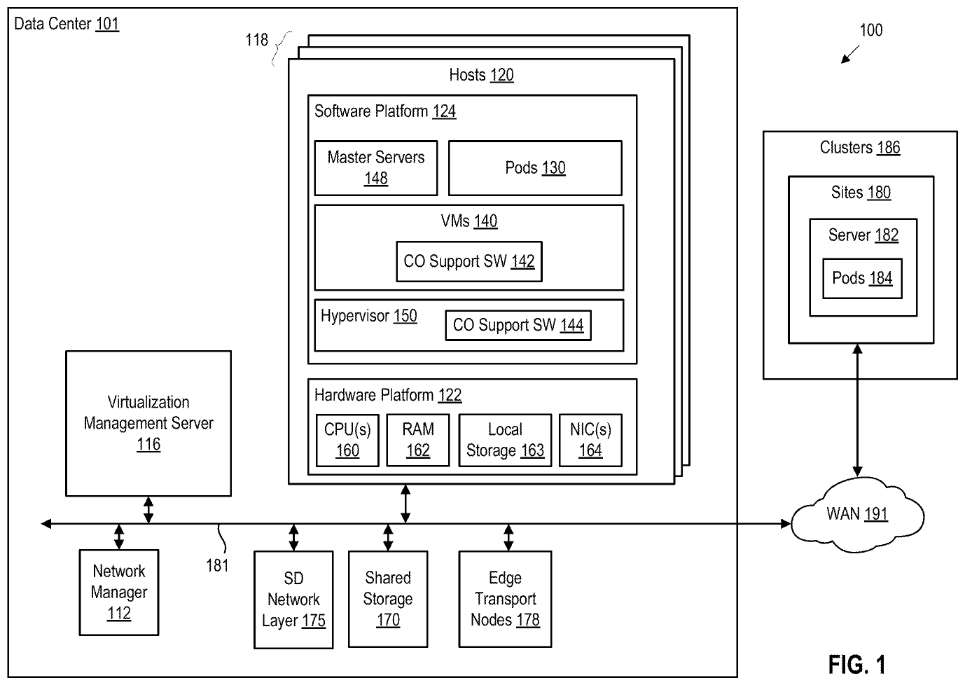

FIG. 1 is a block diagram of a virtualized computing system 100 in which embodiments described herein may be implemented. Virtualized computing system includes a data center 101 in communication with a plurality of sites 180 through a wide area network (WAN) 191 (e.g., the public Internet). Sites 180 can be geographical dispersed with respect to each other and with respect to data center 101. For example, sites 180 can be part of a radio access network (RAN) dispersed across a geographic region and serving different portions of such geographic region. Sites 180 can be organized into clusters 186, where each cluster 186 comprises a plurality of sites 180. In embodiments, data center 101 comprises a software-defined data center (SDDC) deployed in a cloud, such as a public cloud, private cloud, or multi-cloud system (e.g., a hybrid cloud system). In other embodiments, data center 101 can be deployed by itself outside of any cloud environment.

Data center 101 includes hosts 120. Hosts 120 may be constructed on hardware platforms such as an x86 architecture platforms. One or more groups of hosts 120 can be managed as clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 181. Physical network 181 enables communication between hosts 120 and between other components and hosts 120 (other components discussed further herein).

In the embodiment illustrated in FIG. 1, hosts 120 access shared storage 170 by using NICs 164 to connect to network 181. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks, flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN, which is another form of shared storage 170.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, CA.

Virtualized computing system 100 is configured with a software-defined (SD) network layer 175. SD network layer 175 includes logical network services executing on virtualized infrastructure of hosts 120. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to WAN 191. Edge transport nodes 178 can include a gateway (e.g., implemented by a router) between the internal logical networking of host cluster 118 and the external network. Edge transport nodes 178 can be physical servers or VMs. Virtualized computing system 100 also includes physical network devices (e.g., physical routers/switches) as part of physical network 181, which are not explicitly shown.

Virtualization management server 116 is a physical or virtual server that manages hosts 120 and the hypervisors therein. Virtualization management server 116 installs agent(s) in hypervisor 150 to add a host 120 as a managed entity. Virtualization management server 116 can logically group hosts 120 into host cluster 118 to provide cluster-level functions to hosts 120, such as VM migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118. While only one virtualization management server 116 is shown, virtualized computing system 100 can include multiple virtualization management servers each managing one or more host clusters.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents in hypervisor 150 to add a host 120 as a managed entity, referred to as a transport node. One example of an SD networking platform that can be configured and used in embodiments described herein as network manager 112 and SD network layer 175 is a VMware NSX® platform made commercially available by VMware, Inc. of Palo Alto, CA. In other embodiments, SD network layer 175 is orchestrated and managed by virtualization management server 116 without the presence of network manager 112.

In embodiments, sites 180 perform software functions using containers. For example, in a RAN, sites 180 can include container network functions (CNFs) deployed as pods 184 by a container orchestrator (CO), such as Kubernetes. The CO control plane includes a master server 148 executing in host(s) 120. A master server 148 can execute in VM(s) 140 and includes various components, such as an application programming interface (API), database, controllers, and the like. A master server 148 is configured to deploy and manage pods 184 executing in sites 180. In some embodiments, a master server 148 can also deploy pods 130 on hosts 120 (e.g., in VMs 140). At least a portion of hosts 120 comprise a management cluster having master servers 148 and pods 130.

In embodiments. VMs 140 include CO support software 142 to support execution of pods 130. CO support software 142 can include, for example, a container runtime, a CO agent (e.g., kubelet), and the like. In some embodiments, hypervisor 150 can include CO support software 144. In embodiments, hypervisor 150 is integrated with a container orchestration control plane, such as a Kubernetes control plane. This integration provides a “supervisor cluster” (i.e., management cluster) that uses VMs to implement both control plane nodes and compute objects managed by the Kubernetes control plane. For example. Kubernetes pods are implemented as “pod VMs,” each of which includes a kernel and container engine that supports execution of containers. The Kubernetes control plane of the supervisor cluster is extended to support VM objects in addition to pods, where the VM objects are implemented using native VMs (as opposed to pod VMs). In such case, CO support software 144 can include a CO agent that cooperates with a master server 148 to deploy pods 130 in pod VMs of VMs 140.

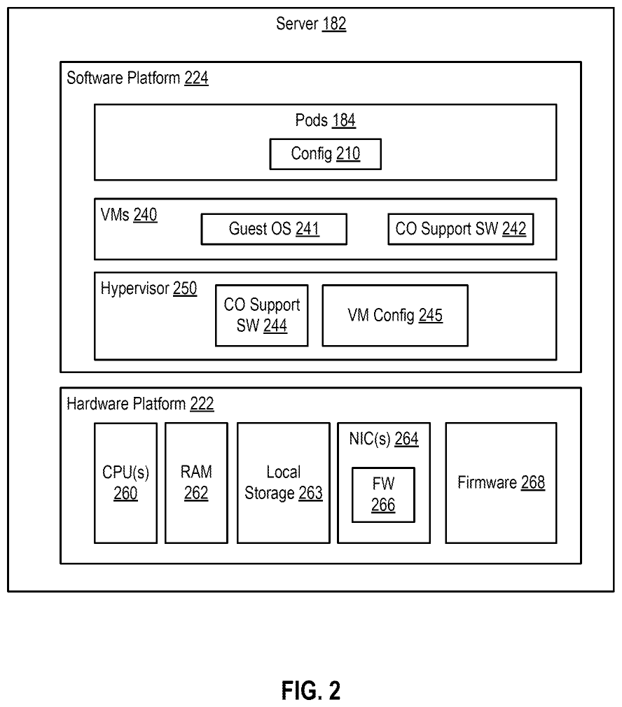

FIG. 2 is a block diagram depicting a server 182 of a site 180 according to embodiments. Server 182 may be constructed on a hardware platform such as an x86 architecture platform. As shown, a hardware platform 222 of server 182 includes conventional components of a computing device, such as one or more CPUs 260, system memory (e.g., RAM 262), one or more NICs 264, firmware 268 (e.g., BIOS or the like), and local storage 263. CPUs 260 are configured to execute instructions, for example, executable instructions that perform one or more operations described herein, which may be stored in RAM 262. NICs 264 enable server 182 to communicate with other devices (i.e., data center 101). In the example, NICs 264 have firmware 266.

A software platform 224 of server 182 includes a hypervisor 250, which directly executes on hardware platform 222. In an embodiment, there is no intervening software, such as a host OS, between hypervisor 250 and hardware platform 222. Thus, hypervisor 250 is a Type-1 hypervisor (also known as a “bare-metal” hypervisor). Hypervisor 150 supports multiple VMs 240, which may be concurrently instantiated and executed. Pods 184 execute in VMs 240 and have a configuration 210. For example, pods 184 can execute network functions (e.g., containerized network functions (CNFs)). In embodiments. VMs 240 include CO support software 242 and a guest operating system (OS) 241 to support execution of pods 184. CO support software 242 can include, for example, a container runtime, a CO agent (e.g., kubelet), and the like. Guest OS 241 can be any commercial operating system (e.g., Linux®). In some embodiments, hypervisor 250 can include CO support software 244 that functions as described above with hypervisor 150. Hypervisor 250 can maintain VM config data 245 for VMs 240.

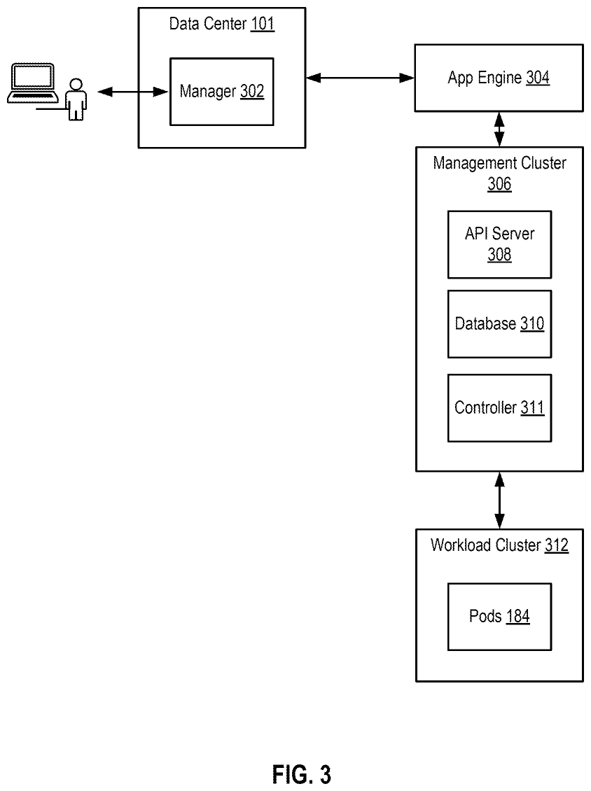

FIG. 3 is a block diagram depicting a CO system according to embodiments. The CO system comprises a manager 302 executing in datacenter 101, an application (app) engine 304, a management cluster 306, and a workload cluster 312. Management cluster 306 comprises servers 182 disposed at one or more sites 180 (e.g., one of clusters 186). In another embodiment, management cluster 306 comprises servers disposed in datacenter 101 or another datacenter. Management cluster 306 comprises an application programming interface (API) server 308, a database 310, and a controller 311. App engine 304 can execute in any cluster (e.g., management cluster 306, workload cluster 312) or in data center 101.

A user or software interacts with API server 308 to define resources for the CO system, such as pods, deployments, services, and the like. The user or software specifies, through API server 308, states of the resources and management cluster 306 executes workflows to apply and maintain the states. In embodiments, the user or software interacts with API server 308 to define custom resources (CRs). CRs are extensions of the resources supported by management cluster 306. Management cluster 306 delegates management of CRs to a controller 311.

In embodiments, a user interacts with manager 302 in datacenter 101 to deploy workload cluster 312 as a CR in the CO system. Workload cluster 312 includes pods 184 that can execute various CNFs. Deployment of workload cluster 312 can be a long running process, as described further herein. Manager 302 is configured to receive the user's request to deploy a CR (e.g., workload cluster 312) and generates an intent identifier associated with the request. Manager 302 sends intent identifiers for requests to app engine 304. App engine 304 stores unique intent identifiers in database 310, one for each CR. For example, a user submits a request to create a CR to manager 302, manager 302 generates a corresponding intent identifier, and manager 302 sends the intent identifier to app engine 304. App engine 304 queries database 310 for any intent identifier that exists for the CR. If none exists, app engine 304 stores the intent identifier in the database 310 in relation to the CR. If, however, there is a previous intent identifier for the request in database 310, app engine 304 replaces the previous intent identifier with the new intent identifier.

Manager 302 sends the CR requests to app engine 304. App engine 304 handles the CR requests depending on intent identifiers in database 310. For example, upon receiving a request, app engine 304 queries database 310 for an intent identifier for the CR in the request. If none exists, app engine 304 drops the request. If an intent identifier exists, app engine 304 forwards the request to API server 308. API server 308 in turn updates the state of the CR in database 310. Controller 311 monitors database 310 for state updates to CRs for which it is configured to monitor (e.g., CRs for creating workload clusters). Controller 311 detects the state update to the CR and executes a management process. The management process can include, for example, deploying workload cluster 312 having pods 184, consistent the state of the CR in database 310.

The management process can be a long-running process. By “long-running,” it is meant that the user may submit one more updated requests for the CR while the management process executes. For example, the user can submit a first request to create the CR, which triggers execution of a first management process (e.g., creation of workload cluster 312 according to a first state in the first request). While that first management process is running, the user may then submit a second request to create/update the CR. Thus, the first management process is “long-running” in the sense that the user has time to submit additional request(s) for the same CR before the first management process is complete.

Consider the case where the user submits a second request for the CR while the first management process is executing and before the first management process completes. Manager 302 creates a new intent identifier unique to the second request. Manager 302 sends the new intent identifier to app engine 304. App engine 304 queries database 310 and determines that a different intent identifier exists for the CR (the one for the first request). App engine 304 replaces the first intent identifier with the second intent identifier. In an embodiment, upon replacement of the intent identifier, app engine 304 cooperates with controller 311 to terminate the first management process. Termination of the management process can also include a cleanup process to rollback any changes to the CO system that were partially made during the management process. In another embodiment, controller 311 monitors for state changes associated with the CR, which includes the change in intent identifier. Controller 311, upon detecting a change in intent identifier while the management process is still executing, can terminate the management process and optionally execute a cleanup process.

Manager 302 also forwards the second request to app engine 304. App engine 304 verifies that the intent identifier in the second request matches that stored in database 310 for the CR. App engine 304 then forwards the second request to API server 308, which updates the state of the CR in database 310. Controller 311 again notices the state update for the CR in database 310 and executes a second management process to enforce the state change.

In this manner, a user can submit a first request to create workload cluster 312. While workload cluster 312 is being created according to a first state, the user can submit a second request to create workload cluster 312 according to a different state from the first request. Management cluster 306 will stop the first management process and execute a second management process based on the second request. No conflict between the two requests occurs due to the use of the intent identifier for the CR.

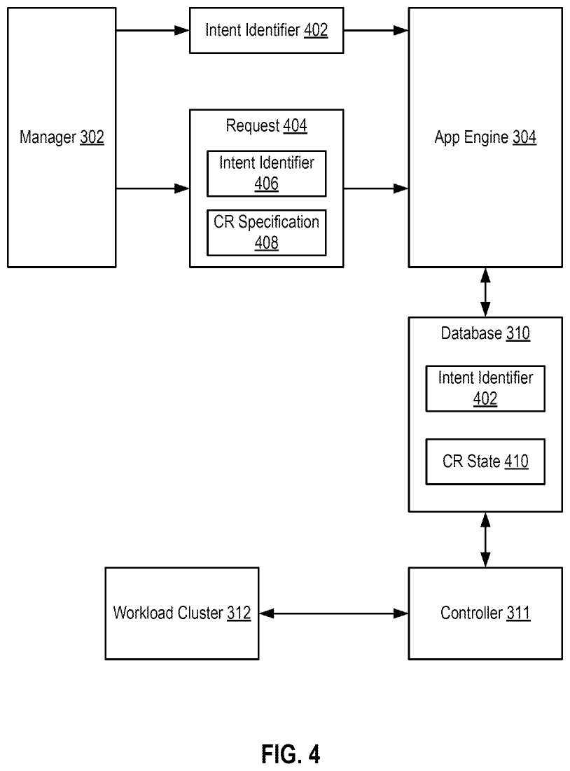

FIG. 4 is a block diagram depicting data flow in the CO system according to embodiments. Manager 302 sends intent identifiers 402 for requests to app engine 304. Each intent identifier 402 is unique to a specific request and each request updates state of a CR. For example, a first request can update state of a first CR (e.g., a workload cluster) and a second request can update state of the first CR in a different manner. That is, a user can create a workload cluster in a first request and then update or delete the workload cluster in a second request. For each request, manager 302 generates a different intent identifier 402. App engine 304 stores intent identifiers 402 in database 310 in association with correspond CRs. Each CR has at most one intent identifier associated therewith. In the example, app engine 304 stores a first intent identifier for the CR based on the first request. Thereafter, app engine 304 replaces the first intent identifier with the second intent identifier when the user submits the second request. Database 310 also stores CR state 410 for the CR. Manager 302 forwards requests 404 to app engine 304. Each request 404 includes a CR specification 408 (that defines CR state) and a corresponding intent identifier 406 that is the current intent identifier for the CR. Controller 311 monitors database 310 for changes in CR state 410. Controller 311 executes management processes in response to changes in CR state 410 in order to enforce the state changes. For example, controller 311 can deploy workload cluster 312 based on CR state 410.

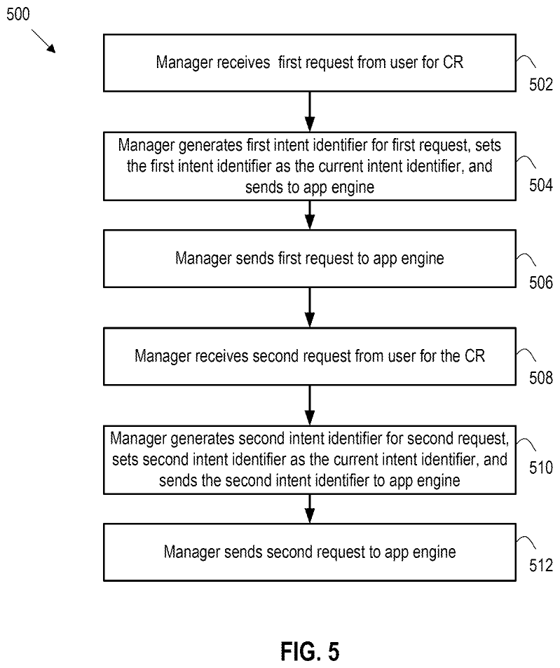

FIG. 5 is a flow diagram depicting a method 500 of handling CR requests in a CO system according to embodiments. Method 500 begins at step 502, where manager 302 receives a first request from a user for a CR. The first request specifies a first state for the CR (e.g., a workload cluster). At step 504, manager 302 generates a first intent identifier for the first request, sets the first intent identifier as the current intent identifier for the CR, and sends the current intent identifier to the app engine. At step 506, manager 302 forwards the first request to the app engine. Those skilled in the art will appreciate that the CO system can include multiple management clusters and that the manager can duplicate the processes described herein for multiple management clusters.

At step 508, manager 302 receives a second request for the CR from the user. The second request includes different state for the CR than the first request (e.g., updated state or deleted state). At step 510, manager 302 generates a second intent identifier for the second request, sets the second intent identifier as the current intent identifier for the CR, and sends the current intent identifier to the app engine. At step 512, manager 302 sends the second request to the app engine. Those skilled the art will appreciate that the user can submit any number of requests for the CR to manager 302 (two requests are shown by way of example).

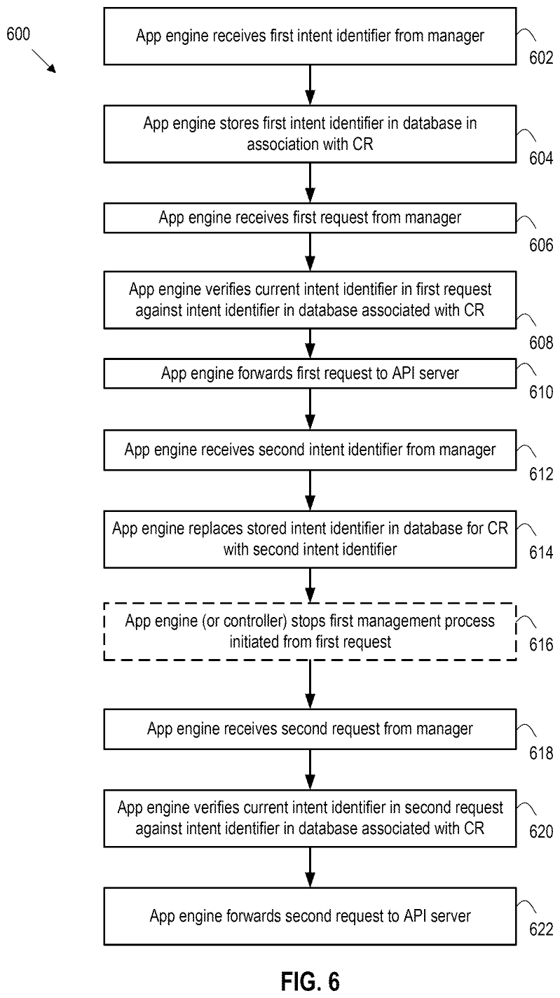

FIG. 6 is a flow diagram depicting a method 600 of executing management processes in response to CR requests in a CO system according to embodiments. Method 600 begins at step 602, where app engine 304 receives the first intent identifier from manager 302. At step 604, app engine 304 stores the first intent identifier in database 310 in association with the CR. At step 606, app engine 304 receives the first request from manager 302. At step 606, app engine 304 verifies the current intent identifier in the first request with the stored intent identifier in database 310 for the CR. If the intent identifiers match, app engine 304 verifies the request. Otherwise, app engine 304 drops the request. Assume in the example the intent identifiers match and app engine 304 verifies the first request.

At step 610, app engine 304 forwards the first requests to API server 308. At step 612, app engine 304 receives the second intent identifier from manager 302. In this case, as described in the example of FIG. 5, the second intent identifier is now the current intent identifier for the CR. At step 614, app engine 304 replaces the stored intent identifier in database 310 with the current intent identifier (the second intent identifier). At step 616, this replacement triggers either app engine 304 or controller 311 to terminate the first management process (initiated by forwarding the first request to API server 308, as described above).

At step 618, app engine 304 receives the second request from manager 302. At step 620, app engine 304 verifies the current intent identifier in the second request with the stored intent identifier in database 310 for the CR. If the intent identifiers match, app engine 304 verifies the request. Otherwise, app engine 304 drops the request. Assume in the example the intent identifiers match and app engine 304 verifies the second request. At step 622, app engine 304 forwards the second request to API server 308. This will trigger a second management process initiated by controller 311 in response to a state update for the CR in database 310 by the second request.

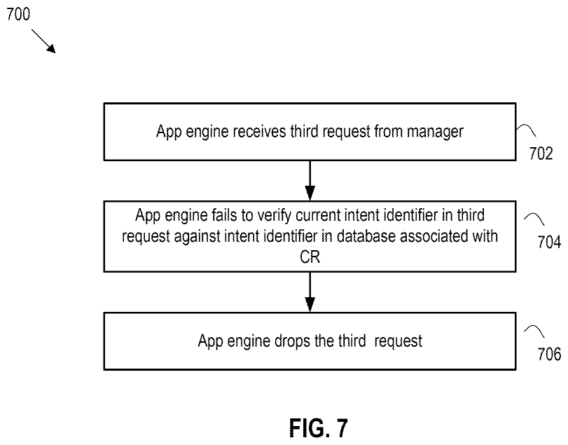

FIG. 7 is a flow diagram depicting a method 700 of executing management processes in response to CR requests in a CO system according to embodiments. Method 700 begins at step 702, where app engine 304 receives a third request from manager 302. At step 704, app engine fails to verify that the intent identifier in the third request matches the stored intent identifier in database 310 associated with the CR. For example, may have submitted a fourth request for the CR before app engine 304 could process the third request. In such case, the fourth request will have generated a forth intent identifier and the app engine 304 will have updated the stored intent identifier for the CR to the fourth intent identifier. Then, when processing the third request, app engine 304 will determine that that the intent identifiers do not match. In such case, at step 706, app engine 304 drops the third request. App engine 304 can then receive the fourth request and proceed as described above in FIG. 6.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The terms computer readable medium or non-transitory computer readable medium refer to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Certain embodiments as described above involve a hardware abstraction layer on top of a host computer. The hardware abstraction layer allows multiple contexts to share the hardware resource. These contexts can be isolated from each other, each having at least a user application running therein. The hardware abstraction layer thus provides benefits of resource isolation and allocation among the contexts. Virtual machines may be used as an example for the contexts and hypervisors may be used as an example for the hardware abstraction layer. In general, each virtual machine includes a guest operating system in which at least one application runs. It should be noted that, unless otherwise stated, one or more of these embodiments may also apply to other examples of contexts, such as containers. Containers implement operating system-level virtualization, wherein an abstraction layer is provided on top of a kernel of an operating system on a host computer or a kernel of a guest operating system of a VM. The abstraction layer supports multiple containers each including an application and its dependencies. Each container runs as an isolated process in user-space on the underlying operating system and shares the kernel with other containers. The container relies on the kernel's functionality to make use of resource isolation (CPU, memory, block I/O, network, etc.) and separate namespaces and to completely isolate the application's view of the operating environments. By using containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific configurations. Other allocations of functionality are envisioned and may fall within the scope of the appended claims. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of managing a custom resource in a container orchestration (CO) system, the method comprising:
receiving, from a manager at a management cluster of the CO system, an intent identifier, the management cluster including a controller configured to manage the custom resource, the management cluster storing the intent identifier in a database;
receiving, from the manager at the management cluster, a request that updates state of the custom resource;
determining, at the management cluster, a match between an intent identifier in the request and the intent identifier stored in the database; and
executing, by the controller of the management cluster, a management process for the custom resource in the CO system in response to the match and the request.

2. The method of claim 1, wherein the intent identifier stored in the database comprises a first intent identifier, the request comprises a first request, and the management process comprises a first management process, the method further comprising:
receiving, from the manager at the management cluster, a second intent identifier different from the first intent identifier;
replacing, by the management cluster, the first intent identifier with the second intent identifier in the database;
receiving, from the manager at the management cluster, a second request that updates the state of the custom resource;
determining, at the management cluster, another match between an intent identifier in the second request and the second intent identifier stored in the database; and
executing, by the controller of the management cluster, a second management process for the custom resource in the CO system in response to the other match and the second request.

3. The method of claim 2, wherein the management cluster stops the first management process in response to replacement of the first intent identifier with the second intent identifier.

4. The method of claim 1, wherein the manager executes in a datacenter and the management cluster executes in a site remote from the datacenter.

5. The method of claim 4, wherein the custom resource comprises a workload cluster configured to execute at the site or another site remote from the datacenter.

6. The method of claim 1, wherein the request comprises a first request, the method further comprising:
receiving, from the manager at the management cluster, a second request that updates the state of the custom resource;
determining, by the management cluster, that a difference between an intent identifier in the second request and the intent identifier stored in the database; and
dropping, by the management cluster, the second request in response to the difference.

7. The method of claim 1, wherein the custom resource comprises a workload cluster, wherein the management process comprises deployment of the workload cluster, wherein the CO system comprises a data center and a plurality of sites, the management cluster disposed in the data center, the workload cluster disposed in the plurality of sites, the workload cluster executing containerized network functions (CNFs).

8. A non-transitory computer readable medium comprising instructions to be executed in a computing device to cause the computing device to carry out a method of managing a custom resource in a container orchestration (CO) system, the method comprising:
receiving, from a manager at a management cluster of the CO system, an intent identifier, the management cluster including a controller configured to manage the custom resource, the management cluster storing the intent identifier in a database;
receiving, from the manager at the management cluster, a request that updates state of the custom resource;
determining, at the management cluster, a match between an intent identifier in the request and the intent identifier stored in the database; and
executing, by the controller of the management cluster, a management process for the custom resource in the CO system in response to the match and the request.

9. The non-transitory computer readable medium of claim 8, wherein the intent identifier stored in the database comprises a first intent identifier, the request comprises a first request, and the management process comprises a first management process, the method further comprising:
receiving, from the manager at the management cluster, a second intent identifier different from the first intent identifier;
replacing, by the management cluster, the first intent identifier with the second intent identifier in the database;
receiving, from the manager at the management cluster, a second request that updates the state of the custom resource;
determining, at the management cluster, another match between an intent identifier in the second request and the second intent identifier stored in the database; and
executing, by the controller of the management cluster, a second management process for the custom resource in the CO system in response to the other match and the second request.

10. The non-transitory computer readable medium of claim 9, wherein the management cluster stops the first management process in response to replacement of the first intent identifier with the second intent identifier.

11. The non-transitory computer readable medium of claim 8, wherein the manager executes in a datacenter and the management cluster executes in a site remote from the datacenter.

12. The non-transitory computer readable medium of claim 11, wherein the custom resource comprises a workload cluster configured to execute at the site or another site remote from the datacenter.

13. The non-transitory computer readable medium of claim 8, wherein the request comprises a first request, the method further comprising:
receiving, from the manager at the management cluster, a second request that updates the state of the custom resource;
determining, by the management cluster, that a difference between an intent identifier in the second request and the intent identifier stored in the database; and
dropping, by the management cluster, the second request in response to the difference.

14. The non-transitory computer readable medium of claim 8, wherein the custom resource comprises a workload cluster, and wherein the management process comprises deployment of the workload cluster.

15. A computer system, comprising:
a hardware platform;
software, executing on the hardware platform, configured to:
receive, from a manager, an intent identifier, the software including a controller configured to manage a custom resource of a container orchestration (CO) system, the software storing the intent identifier in a database;
receive, from the manager, a request that updates state of the custom resource;
determine a match between an intent identifier in the request and the intent identifier stored in the database; and
execute, by the controller, a management process for the custom resource in the CO system in response to the match and the request.

16. The computer system of claim 15, wherein the intent identifier stored in the database comprises a first intent identifier, the request comprises a first request, and the management process comprises a first management process, and wherein the software is configured to:
receive, from the manager, a second intent identifier different from the first intent identifier;
replace the first intent identifier with the second intent identifier in the database;
receive, from the manager, a second request that updates the state of the custom resource;
determine another match between an intent identifier in the second request and the second intent identifier stored in the database; and
execute, by the controller, a second management process for the custom resource in the CO system in response to the other match and the second request.

17. The computer system of claim 16, wherein the software stops the first management process in response to replacement of the first intent identifier with the second intent identifier.

18. The computer system of claim 15, wherein the manager executes in a datacenter and the software executes in a site remote from the datacenter.

19. The computer system of claim 18, wherein the custom resource comprises a workload cluster configured to execute at the site or another site remote from the datacenter.

20. The computer system of claim 15, wherein the request comprises a first request, and wherein the software is configured to:
receive, from the manager, a second request that updates the state of the custom resource;
determine that a difference between an intent identifier in the second request and the intent identifier stored in the database; and
drop the second request in response to the difference.
